(19) United States
(12) Patent Application Publication
(10) Pub. No.: US 2015/0273987 A1
(43) Pub. Date: Oct. 1, 2015

(54) Protective Barrier for Motor Vehicles

(71) Applicant: GTT Fabrication, INC., San Antonio, TX (US)

(72) Inventor: Matthew J. O'Leary, San Antonio, TX (US)

(21) Appl. No.: 14/229,401

(22) Filed: Mar. 28, 2014

(51) Int. Cl. B60J 1/20; B60K 13/04

(52) U.S. Cl. CPC B60J 1/2094; B60K 13/04

(57) ABSTRACT

A protective barrier for a motor vehicle has a wall structure removably securable to a motor vehicle. At least one tubular structure is in the wall structure and is configured to be coupled in fluid communication with an exhaust system of a motor vehicle.

### TECHNICAL FIELD

The technical field of this application disclosure relates to protective barriers for motor vehicles.

### BACKGROUND OF THE INVENTION

There is always a need for improving the design for protective barriers used to protect the cabs of motor vehicles.

### SUMMARY

An aspect of the disclosure, as a non-limiting example only, includes a protective barrier for a motor vehicle that has a wall structure removably securable to a motor vehicle. At least one tubular structure is in the wall structure and is configured to be coupled in fluid communication with an exhaust system of a motor vehicle.

Another aspect of the disclosure, as a non-limiting example only, includes a protective barrier for a motor vehicle that has a wall structure and a securement device that is configured to removably secure the wall structure to a motor vehicle. The securement device includes an adjustment capability allowing the wall structure to be removably secured to differently dimensioned motor vehicles.

Still another aspect of the disclosure, as a non-limiting example only, includes a protective barrier for a motor vehicle that has a frame removably securable to a motor vehicle. The frame defines a window region. The protective barrier includes a hollow structure in the frame and defines a passageway configured to be in fluid communication with an exhaust system of the motor vehicle.

### BRIEF DESCRIPTION OF THE DRAWINGS

FIG. 1 is a perspective view of an exemplary embodiment of the disclosure provided on a motor vehicle;

FIG. 2 is a side view of the exemplary embodiment of the disclosure of FIG. 1;

FIG. 3 is a perspective and partial break-away view of an exemplary embodiment of the disclosure coupled to an exhaust system of the motor vehicle;

FIG. 4 is a side view of an exemplary embodiment of the disclosure coupled to an engine and exhaust system;

FIG. 5 is a perspective view of an exemplary embodiment of the disclosure;

FIG. 6 is a rear view of an exemplary embodiment of the disclosure;

FIG. 7 is a top view of an exemplary embodiment of the disclosure;

FIG. 8 is a bottom view of an exemplary embodiment of the disclosure;

FIG. 9 is a first side view of an exemplary embodiment of the disclosure;

FIG. 10 is a second side view of an exemplary embodiment of the disclosure;

FIG. 11 is a perspective view of an exemplary embodiment of the disclosure;

FIG. 12 is a front view of the exemplary embodiment of the disclosure of FIG. 11;

FIG. 13 is a first side view of the exemplary embodiment of the disclosure of FIG. 11;

FIG. 14 is a second side view of the exemplary embodiment of the disclosure of FIG. 11;

FIG. 15 is a rear and perspective view of an exemplary embodiment of the disclosure;

FIG. 16 is a front and perspective view of the exemplary embodiment of the disclosure of FIG. 15;

FIG. 17 is a front and perspective view of an exemplary embodiment of the disclosure;

FIG. 18 is a partial view of the exemplary embodiment of the disclosure of FIG. 17;

FIG. 19 is a partial view of the exemplary embodiment of the disclosure of FIG. 17;

FIG. 20 is a partial perspective view of an exemplary embodiment of the disclosure;

FIG. 21 is a partial perspective view of an exemplary embodiment of the disclosure;

FIG. 22 is a partial perspective and partial break-away view of an exemplary embodiment of the disclosure;

FIG. 23 is a partial perspective view of an exemplary embodiment of the disclosure on a cargo bed of a motor vehicle; and

FIG. 24 is a rear perspective view of an exemplary embodiment of the disclosure.

### DETAILED DESCRIPTION OF THE PREFERRED EMBODIMENTS

This disclosure of this application is submitted in furtherance of the constitutional purposes of the U.S. Patent Laws “to promote the progress of science and useful arts” (Article 1, Section 8).

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

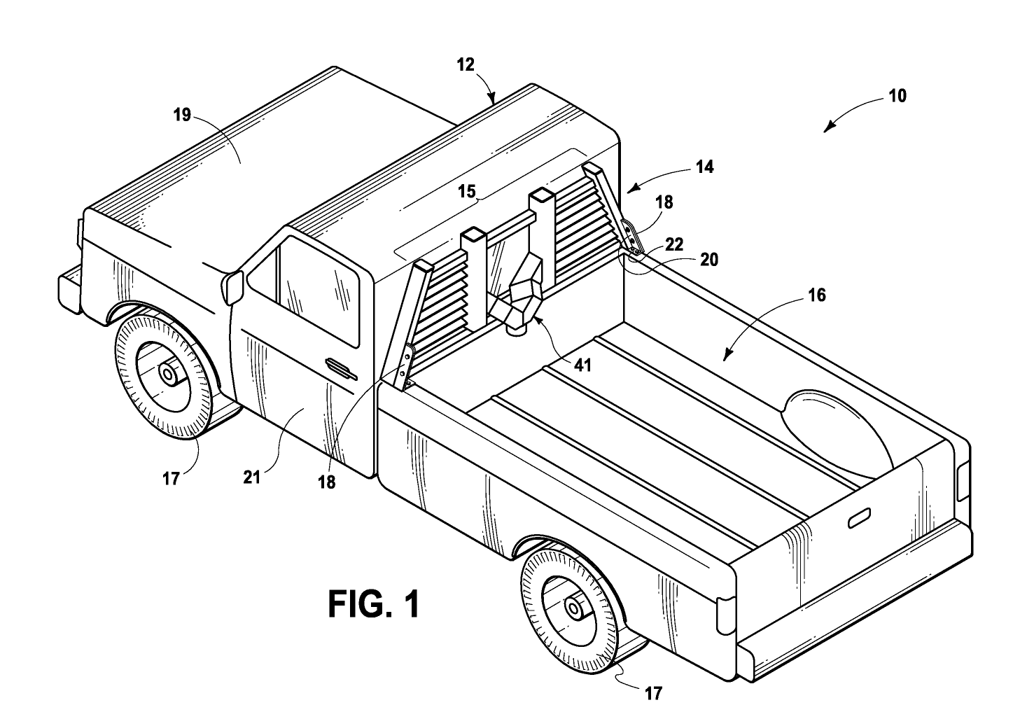

Referring to FIG. 1, an exemplary motor vehicle 10 is illustrated having an exemplary protective barrier 14 not yet coupled to an exhaust system of the motor vehicle 10. An exemplary motor vehicle 10 is a truck and the various inventions disclosed herein are compatible with other vehicles, and as non-limiting examples, vehicles that transport cargo such as semi-trailer trucks. The exemplary protective barrier 14 can be considered and/or referred to as a protective wall, a bulkhead, a bulwark and even a headache rack. An exemplary motor vehicle 10 includes tires 17, hood 19, door 21, a cab 12 to house a driver and/or passengers, and a cargo bed 16 to transport cargo. An overall view of an exemplary protective barrier 14 includes a strong wall-like structure (one non-limiting example here is represented as 15) placed between the cab 12 and the cargo bed 16 of the motor vehicle 10 and a device (one non-limiting example here is represented as 18) to secure the strong wall-like structure to the motor vehicle 10 (hereinafter sometimes referred to as “truck”).

Still referring to FIG. 1, a non-limiting example of a protective barrier 14 includes a wall structure 15 and a securement device such as, as a non-limiting example, a flange structure 18. A truck flange 20 oriented inside of the flange structure 18 is bolted 22 to the cargo bed 16 of the truck 10 and is configured to be mated with the flange structure 18 of protective barrier 14. The flange structure 18 is secured to the truck flange 20 which ultimately secures the protective barrier 14 to the cargo bed 16 of the truck 10. The securement between the flange structure 18 and the truck flange 20 can occur via, as one non-limiting example, with various combinations of bolts and nuts. The protective barrier 14 could have the flange structure 18 welded, or permanently secured to, the truck flange 20 instead of removably secured to the truck flange 20. The protective barrier 14 could have the flange structure 18 directly removable secured to the cargo bed wherein the truck flange 20 is not needed. The protective barrier 14 further includes a coupling device 41 described more thoroughly subsequently.

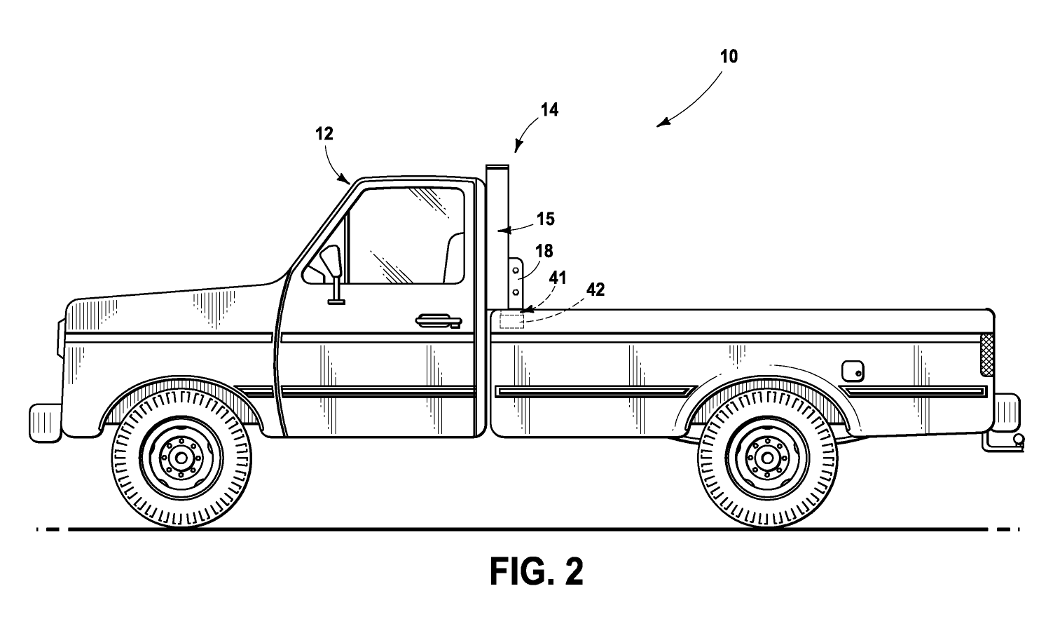

Referring to FIG. 2, FIG. 2 illustrates a side view of the protective barrier 14 secured to truck 10 and having a portion of a coupling device 41 that includes a sleeve 42.

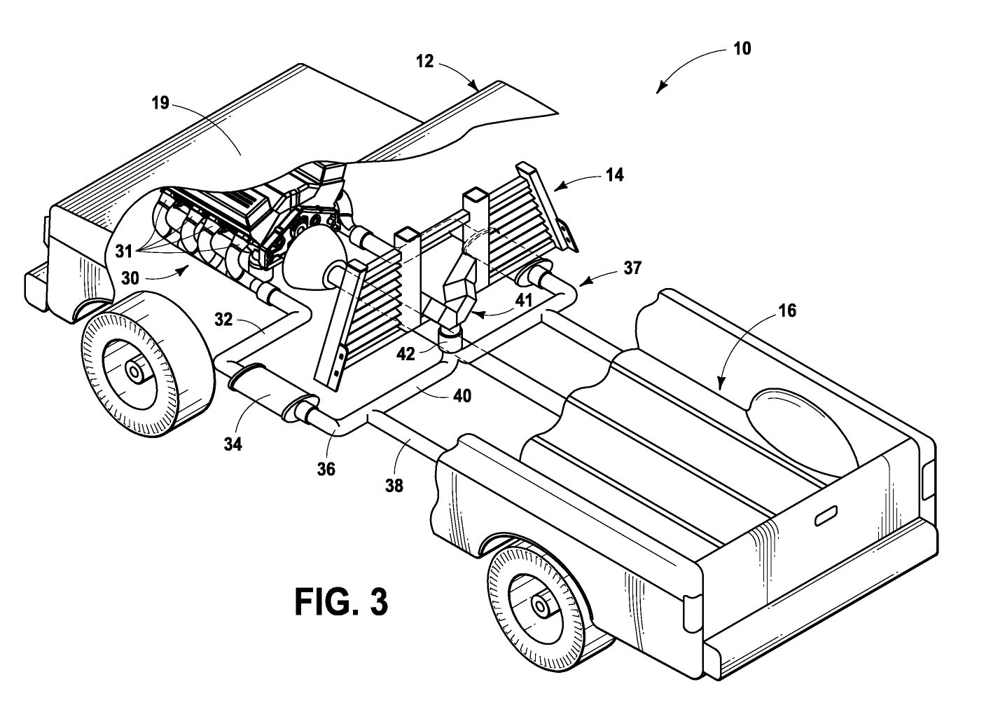

Referring to FIG. 3, the protective barrier 14 is illustrated with the coupling device 41 being coupled to an exemplary exhaust system of truck 10. Motor vehicles such as trucks 10 are powered by internal combustion engines that create exhaust gases during the combustion process. Exhaust gases are toxic. Consequently, exhaust systems are designed to expel exhaust gases away from the truck 10 to avoid affecting occupants in the cab 12 (and ideally without affecting occupants of other motor vehicles in proximity on the road). An exemplary method and design for an exhaust system to perform this task is by routing exhaust gases from exhaust ports 31 of the engine 30 to a position remote from the cab 12.

Still referring to FIG. 3, the exemplary exhaust system includes an exhaust pipe 32 providing fluid communication between the engine 30 (and exhaust ports 31) and a muffler 34. The exhaust system further includes an exhaust pipe 36 providing fluid communication between muffler 34 and exhaust pipes 38 and 40. Exhaust pipe 38 continues under the bed 16 of truck 10 ultimately to open to the environment. Exhaust pipe 40 provides fluid communication between exhaust pipe 38 and coupling device 41 of protective barrier 14. Sleeve 42 secures exhaust pipe 40 to coupling device 41. An exemplary configuration of the securement between sleeve 42 and exhaust pipe 40 includes an inner periphery of sleeve 42 having threads that mate or thread upon corresponding threads on an outer periphery of coupling device 41. Another exemplary configuration of the securement between sleeve 42 and exhaust pipe 40 has the inner periphery of sleeve 42 being dimensioned to slide over the outer periphery of coupling device 41 in a tight and snug fit. Still another exemplary configuration of the securement between sleeve 42 and exhaust pipe 40 has a first portion of the inner periphery of sleeve 42 being dimensioned to slide over a first portion of the outer periphery of coupling device 41 in a tight and snug fit and a second portion of the inner periphery of sleeve 42 having threads that mate or thread upon corresponding threads on a second portion of the outer periphery of coupling device 41. It should be understood that any configuration of the exhaust system is considered that ultimately mates with the protective barrier 14 in fluid communication.

Still referring to FIG. 3, it should be understood that another section of the exemplary exhaust system can extend from the opposite side of engine 30, represented generally as reference number 37, and can include similar elements and structures described above, for example, elements 32, 34, 36, 38 and 40 to ultimately be in secured to and in fluid communication with coupling device 41. Additionally, the another section 37 of the exhaust system will include one exhaust pipe similar to exhaust pipe 38 that opens fluid communication to the environment. It should be understood that truck 10 does not have to include section 37 of the exhaust system. It should be further understood that if truck 10 does include section 37 of the exhaust system, section 37 can be a mirror configuration of elements 32, 34, 36, 38 and 40, or a different configuration.

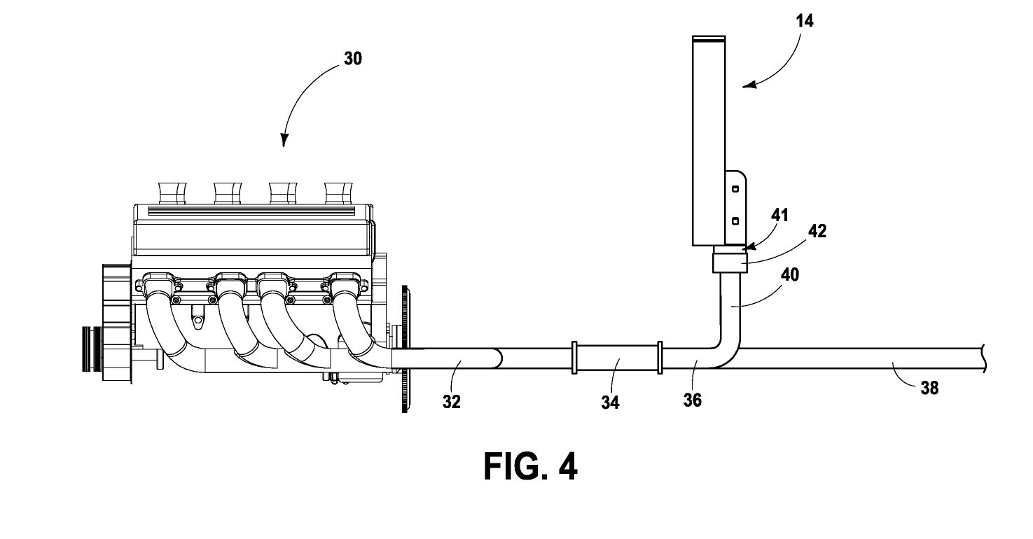

Referring to FIG. 4, a side view of engine 30 is illustrated coupled to protective barrier 14 via elements 32, 34, 36, 38, 40, 42 and 41.

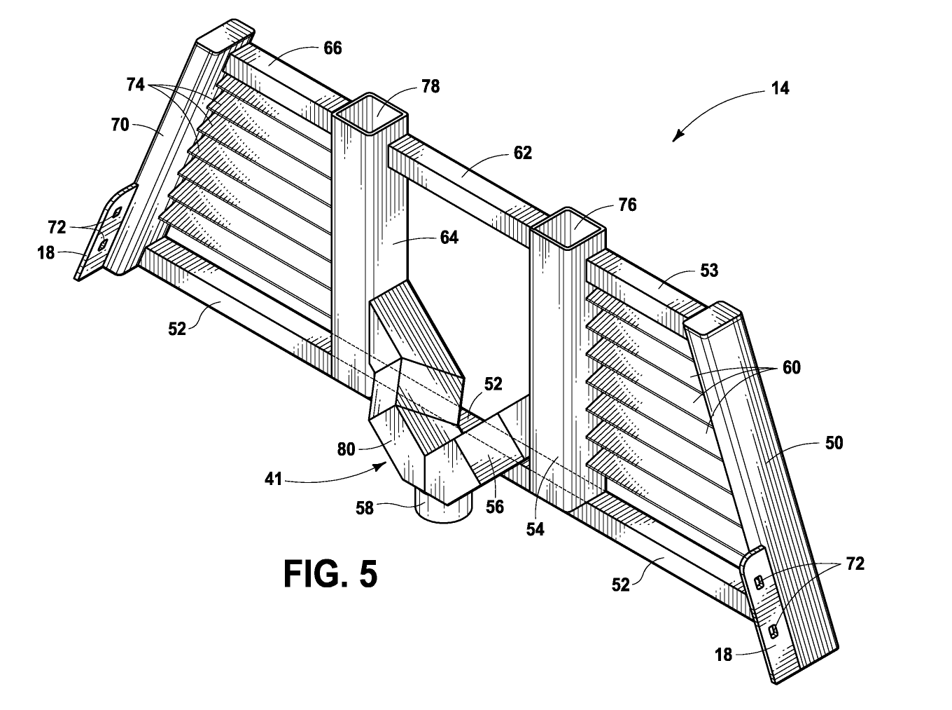

Referring to FIG. 5, a perspective view of one non-limiting example of protective barrier 14. An exemplary overview shape or configuration of this protective barrier 14, as one non-limiting example, is a trapezoid. In fact, this protective barrier 14 has an overview configuration of an isosceles trapezoid. The overview configuration of the protective barrier 14 can have any peripheral shape or configuration including any geometric configuration such as a circle, hexagon, any parallelogram such as rhombuses, rectangles and squares, etc.

Still referring to FIG. 5, opposite side structures 50 and 70 (“legs” in trapezoid nomenclature) are angled to extend upwardly from opposite ends of a common base support 52 that extends generally horizontally or parallel with the floor portion of cargo bed 16 (see FIG. 1). Tail pipes 54 and 64 extend vertically from base support 52 in between side structures 50 and 70. A first upper support 53 extends between side structure 50 and tail pipe 54. A second upper support 62 extends between tail pipes 54 and 64. A third upper support 66 extends between side structure 70 and tail pipe 64. Each one of side structures 50 and 70 has the flange structures 18 extending from the lower end of side structures 50 and 70. Each flange structure 18 as a pair of openings 72 to receive a bolt for connection to a truck or cargo bed flange 20 for securing protective barrier 14 to cargo bed of a truck. (see FIGS. 1-4).

It should be understood that the securement device that collectively includes flanges 18 and 20 can be thought of as having an adjustment capability for allowing the wall structure to be removably secured to differently dimensioned motor vehicles. In effect, the securement device is in sliding engagement with the wall structure. That is, since flange is secured to a cargo bed, the differently dimensioned cargo beds will have the flange 20 differently spaced from the flange 18 wherein a spacer (not shown) can be provided between flanges 18, 20 and then the two flanges 18, 20 are secured to each other. The spacer can have any width or length dimension to accommodate the differently dimensioned cargo beds and to accommodate the differently dimensioned spacing between the respective flanges 18, 20. Furthermore, the spacer can be formed of any material, such as, and as non-limiting examples, rubber, hard rubber, metal, plastic, metal alloy, etc. The spacer will prevent the flanges 18, 20 from bending during the securement of the two together with, for example, bolts.

Still referring to FIG. 5, upper supports 53, 62, 66 can have the same dimensions or different respective dimensions. Exemplary dimensions include each upper support having a 2 inch vertical dimension and a 2 inch deep dimension (dimension extending in and out of the page). Upper support 62 can have a range of length dimensions from 5 inches, 6 inches, 7 inches . . . to 36 inches with an exemplary dimension being 18 inches. To accommodate the angled outermost surfaces, upper supports 53 and 66 will have different length dimensions for upper surface with respect to lower surface. Lower surface dimensions for upper supports 53 and 66 can have a range of length dimensions from 5 inches, 6 inches . . . to 24 inches with an exemplary dimension being 14¾ inches. Upper surface dimensions for upper supports 53 and 66 can have a range of length dimensions from 3 inches, 4 inches . . . to 18 inches with an exemplary dimension being 13 5/16 inches. The outermost surface of upper supports 53 and 66 which are angled from the vertical can have a range of angles from the vertical including 4 degrees, 5 degrees . . . to 70 degrees with an exemplary angle being 20 degrees.

Still referring to FIG. 5, a first set of a plurality of louvers 74 extend between side structure 70 and tail pipe 64 at different elevations between base support 52 and upper support 66. The region or area where the plurality of louvers 74 occupy can be termed, as a non-limiting example, a window region and is defined by side structure 70, tail pipe 64, upper support 66 and a portion of base support 52. A second set of a plurality of louvers 60 extend between side structure 50 and tail pipe 54 at different elevations between base support 52 and upper support 53. The region or area where the plurality of louvers 60 occupy can be termed a window region and is defined by side structure 50, tail pipe 54, upper support 53 and a portion of base support 52. There are seven louvers 74 and seven louvers 60, but it should be understood that there could be a range of louvers including 1, 2, 3, 4, 5, 6, 8 . . . to 9-20 louvers 74 and louvers 60. Furthermore, there could be the same number of louvers 74 as there are louvers 60, and there could be a different number of louvers 74 relative to the number of louvers 60.

It should be understood that any one protective barrier described in this document can have a plurality of window regions, for example, one, two, three, etc., and each can be filled or covered by other structures, some described subsequently. Moreover, the respective window regions can be covered by different structures. For example, one window region can be covered by one structure, such as a screen, while the other window region can be covered by louvers and another window region can be empty (this is, not covered or filled by any material or structure) and in any combination. Furthermore, any one window region can be covered by a plurality of different structures such as half of a single window region is covered with a screen structure while the other half is covered with louvers. Still further, another structure that could cover the window regions is a plastic material or fiberglass, either opaque or clear or semi-clear. Other structures for covering window regions include nets of string, rope, wire or strong tread. Additionally, while not shown, any of these structures or materials can cover or fill the region open between respective tail pipes 64 and 54.

Still referring to FIG. 5, coupling device 41 has a cylindrical portion 58 to receive an exhaust pipe from an exhaust system (see FIG. 3) and V-shaped faceted extensions 56 and 80 that are hollow to provide fluid communication with the exhaust system (see FIGS. 3-4). The V-shaped faceted extensions 56 and 80 open into respective tail pipes 54 and 64. That is, each tail pipe 54 and 64 is hollow and has an opening 76 and 78, respectively, to the environment. Ultimately, exhaust gases from motor vehicle 10 travels through the exhaust system from engine 30, through coupling device 41 and through tail pipes 54 and 64 to be selectively exited to the environment through openings 76 and 78.

Tail pipes 54 and 64 have a square cross-section configuration. It should be understood that tail pipes 54 and 64 could have other cross-sectional configurations, such as geometric cross-sectional configurations, including a circle, hexagon, any parallelogram such as rhombuses and rectangles, etc. Moreover, one tail pipe could have one cross-sectional configuration while the other tail pipe has a different cross-sectional configuration. Side structures 50 and 70 have a rectangular cross-section configuration. It should be understood that side structures 50 and 70 could have other cross-sectional configurations, such as geometric cross-sectional configurations, including a circle, hexagon, any parallelogram such as rhombuses and squares, etc. Furthermore, one side structure could have one cross-sectional configuration while the other side structure has a different cross-sectional configuration. The base support 52 and first, second, third upper supports 53, 62, 66 have a square cross-section configuration. It should be understood that base support 52 and first, second, third upper supports 53, 62, 66 could have other cross-sectional configurations, such as geometric cross-sectional configurations, including a circle, hexagon, any parallelogram such as rhombuses and rectangles, etc. Further, each one of base support 52 and first, second, third upper supports 53, 62, 66 could have one cross-sectional configuration while the other of each of one of base support 52 and first, second, third upper supports 53, 62, 66 has a different cross-sectional configuration.

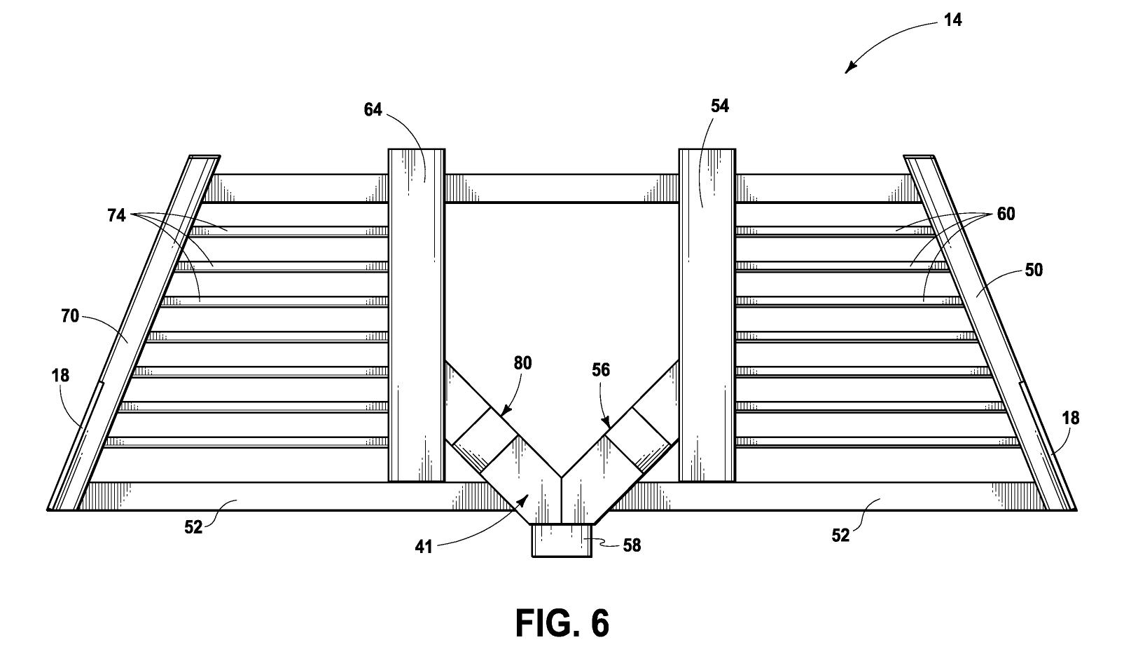

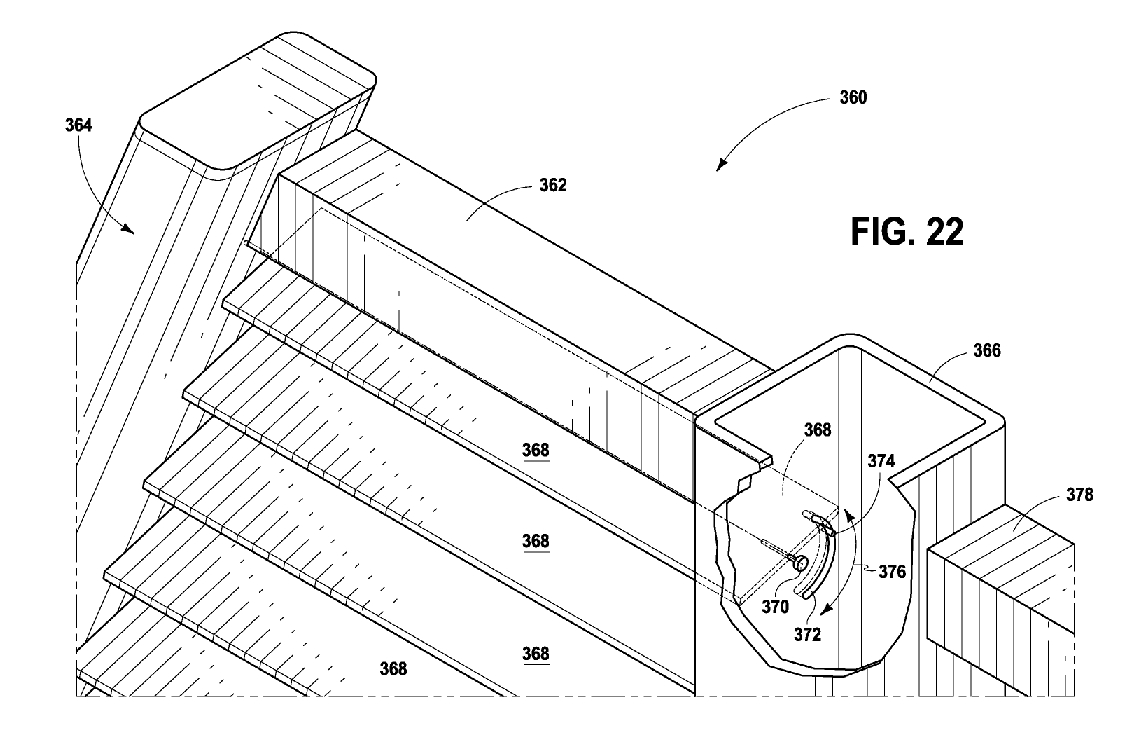

Referring to FIG. 6, the side of protective barrier 14 viewed in this figure is the side that will be facing the cargo bed of the truck when secured to cargo bed (alternatively referred to as the rear side or rear). In this view, one can see that coupling device 41 extends from respective tail pipes 54 and 64 and extends in front of, and extends from above to below, base support 52. Each louver 60 and 74 is shown extending parallel to (along the longitudinal axis extending between respective tail pipes and side structures) to each other louver and would be parallel to a cargo bed if positioned on a truck. It should be understood that any one, and any combination of, louvers could be angled relative to each other louver along respective longitudinal axes extending between respective tail pipes and side structures. It should be further understood that any one, and any combination of, louvers could be rotated about the longitudinal axis relative to each other louver. As non-limiting examples, louvers described throughout this document are removable securable in the window region of the wall structure or frame and configured for rotation about the longitudinal axis defined by the louver. As described subsequently relative to FIG. 22, the louvers, as non-limiting examples, are configured to be selectively positioned in any one of a plurality of incremental angular locations about the longitudinal axis.

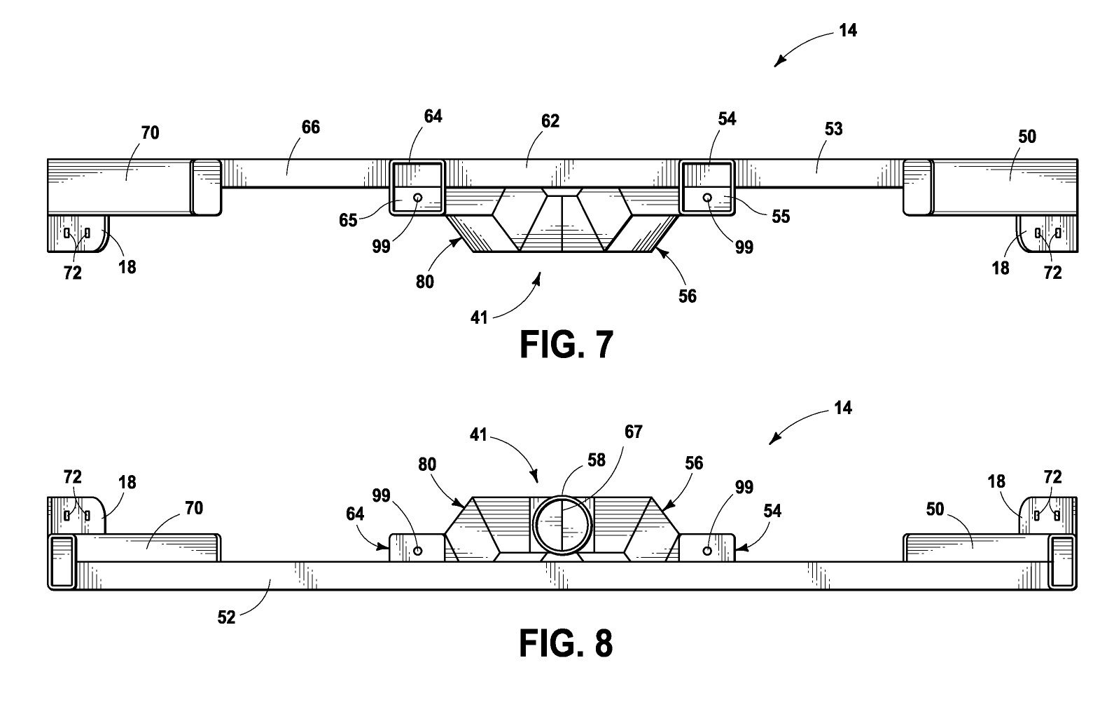

Referring to FIG. 7, a top view of protective barrier 14 is illustrated and such illustrates inner peripheries 65, 55 through openings 78, 76, respectively (see FIG. 5) of each tail pipe 64 and 54.

Referring to FIG. 8, a bottom view of protective barrier 14 is illustrated and such illustrates that each side structure 50 and 70 and each tail pipe 54 and 64 have wider dimensions than the base support 52. In this view, drain openings or holes 99 can be seen in the bottoms of each of tail pipes 54 and 64. Each drain opening 99 will allows for fluids such as rain to drain from each of tail pipes 54 and 64. Moreover, viewing up through the opening in cylindrical portion 58 allows one to view the division line 67 between the V-shaped faceted extensions 56 and 80.

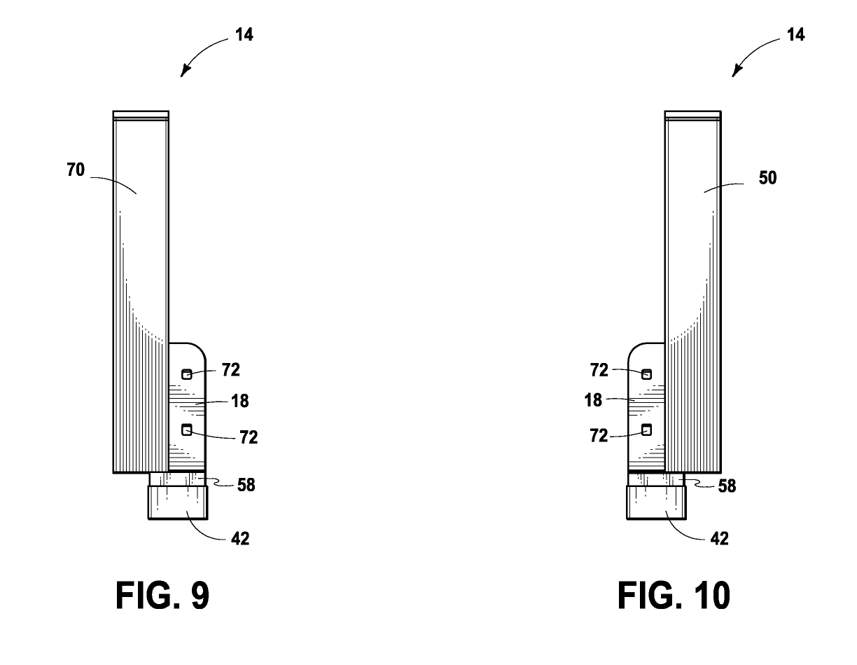

Referring to FIGS. 9 and 10, such illustrates that the configuration of side views of protective barrier 14 are the same. It should be understood that sleeve 42 can be consider a structure of protective barrier 14 or a structure of exhaust system of the motor vehicle (not shown here).

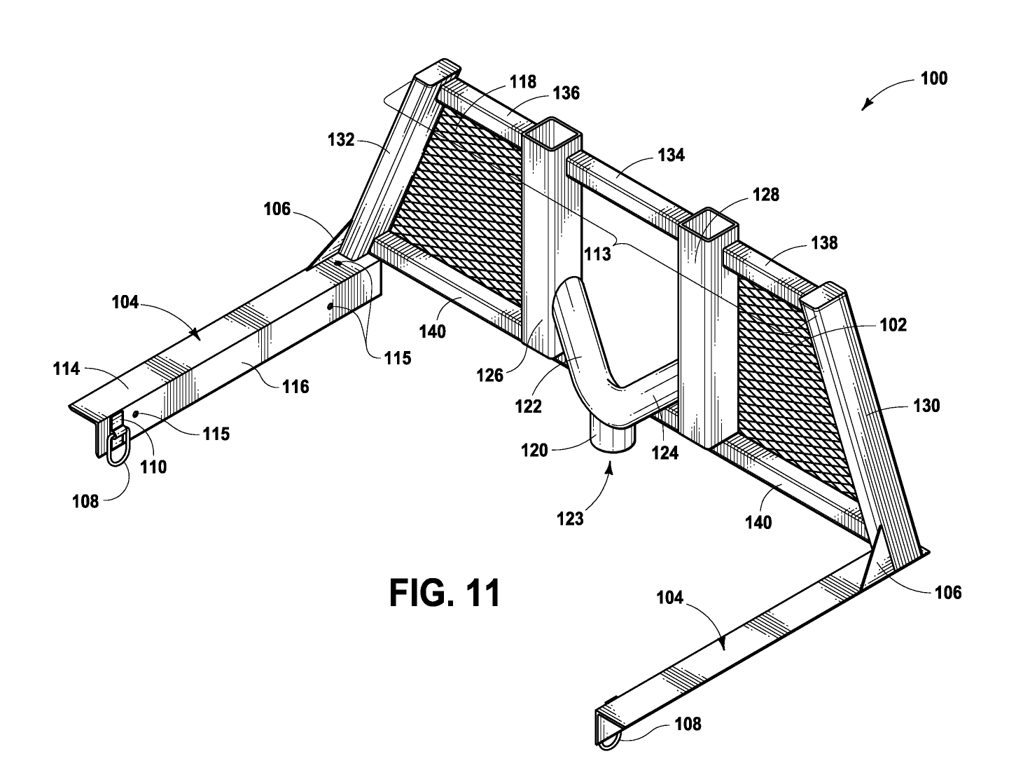

Referring to FIG. 11, a protective barrier 100 is illustrated. Elements/structures 126, 128, 130 132, 134, 136, 138, 140 collectively form a wall structure 113 of protective barrier 100 and correspond to elements/structures of protective barrier 14, and therefore, will not be further discussed. Protective barrier 100 has screens 118, 102 filling or covering window regions instead of louvers 60 and 74 of protective barrier 14. Screen 118 is secured to one or more of the periphery structures which includes elements/structures 126, 132, 136, 140. Screen 102 is secured to one or more of the periphery structures which includes elements/structures 128, 130, 138, 140. Securement of screens 118, 102 can be by bolts/nuts, welds or other binding agents such as glues for metal and/or plastics, and any combination of each. Accordingly, screens 118, 102 can be removable secured, or not, to protective barrier 100. The screen material is oriented in a crisscrossed configuration or pattern leaving openings configured as diamonds. The screen material can be oriented in other configurations or patterns leaving openings configured as other geometric configurations, including a circle, hexagon, any parallelogram such as rhombuses, squares and rectangles, etc.

Still referring to FIG. 11, coupling device 123 has a cylindrical portion 120 configured to receive in, or receive on, an exhaust pipe (and may or may not include a sleeve such as 42 of protective barrier 14) an exhaust system (see FIG. 3) of a motor vehicle. Coupling device 123 includes extensions 122 and 124 that intersect at a curved or arcuate pipe section that intersects/mates with the cylindrical portion 120. Extensions 122, 124 and the curved or arcuate pipe section are cylindrical and hollow to provide fluid communication with the exhaust system (see FIGS. 3-4). The extensions 122 and 124 open into respective tail pipes 126 and 128. That is, each tail pipe 126 and 128 is hollow and has respective openings to the environment. Ultimately, exhaust gases from motor vehicle 10 (FIG. 1) travels through the exhaust system from engine 30, through coupling device 123 and through tail pipes 126 and 128 to be selectively exited to the environment through openings.

Still referring to FIG. 11, a securement device includes, as a non-limiting example, a pair of securement arms 104 (or pair of securement devices) extend generally perpendicularly from wall structure 113 and are secured to respective side structures 130 and 132 and base support 140. Braces 106 are secured between respective side structures 130 and 132 and securement arms 104 to stabilize the connection of securement arms 104 to respective side structures 130 and 132. Each securement arm 104 has a pair of linear, planar structures 114, 116 attached together at a right angle, approximately 90 degrees. Each securement arm 104 has a plurality of openings 115 to ultimately receive bolts for securing the securement arms 104 to an upper surface or sidewalls or ridge periphery of a cargo bed. In this fashion, the protective barrier 100 is secured to a truck. The securement arms 104 include buckles 108 that can be used to receive straps to secure cargo in the cargo bed of a truck. The securement arms 104 do not have to include buckles 108.

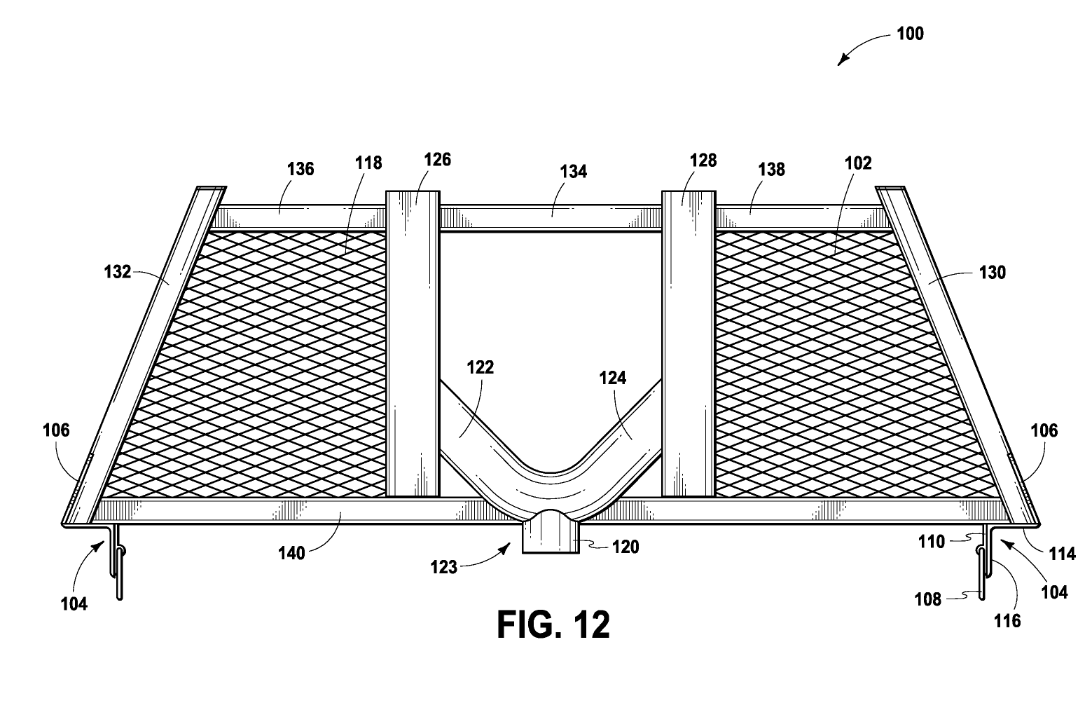

Referring to FIG. 12, this view of illustrates the rear side of protective barrier 100 and shows the right angle configuration of securement arms 104.

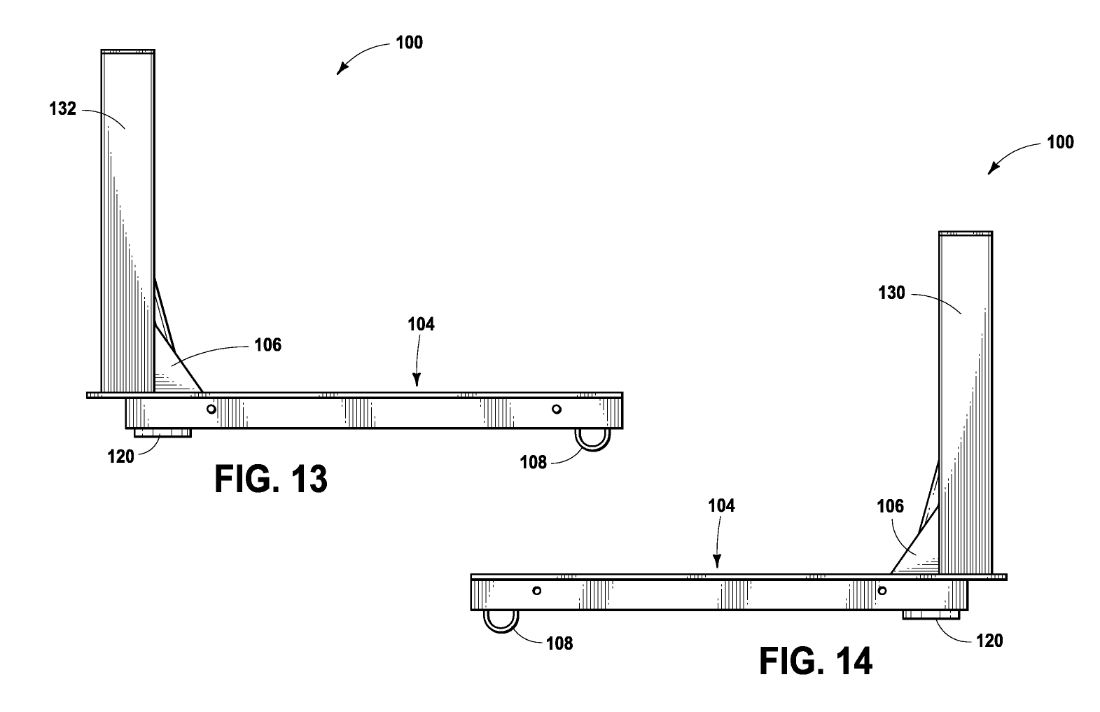

Referring to FIGS. 13-14, side views of protective barrier 100 illustrate the linear structure of respective securement arms 104.

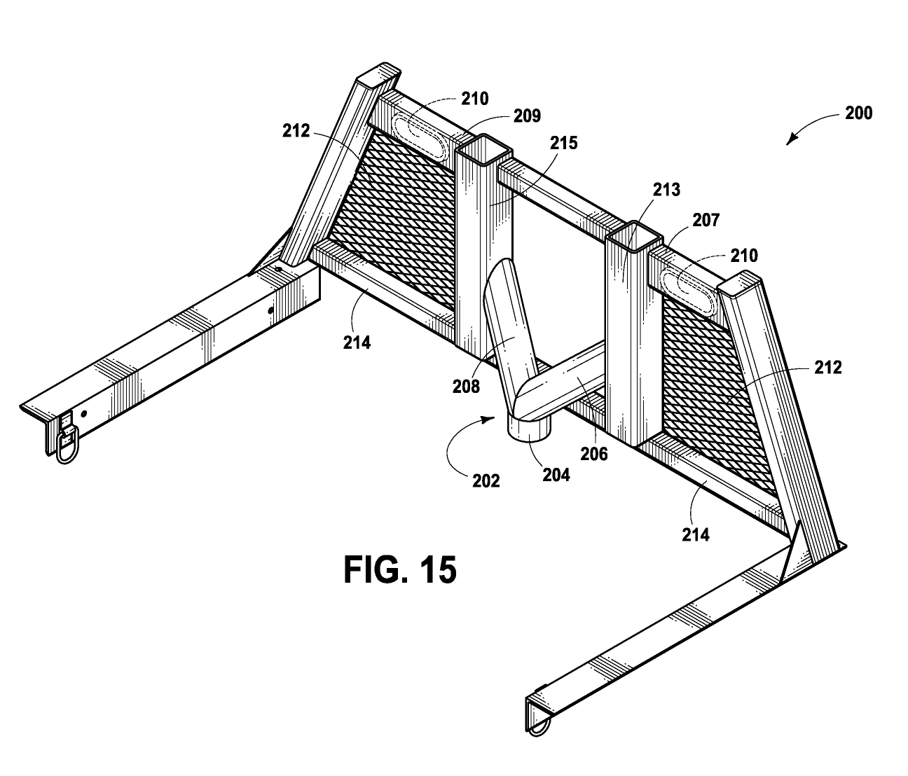

Referring to FIG. 15, a protective barrier 200 is illustrated and has various structures and elements previously discussed regarding previously disclosed protective barriers, and therefore, will not be discussed here. Upper supports 207 and 209 have a rectangular cross-section configuration, and therefore, the vertical dimensions are larger than the upper supports described for previous protective barriers. An exemplary and non-limiting dimension for the upper supports 207 and 209 of protective barrier 200 is 4 inches. On a surface of each upper support 207 and 209 (which would be facing the cargo bed if protective barrier 200 is provided on a truck) is a reflector 210. A reflector could be positioned on only one upper support, or none at all. Alternatively, the reflector 210 could be replaced with a light source that can be selectively turned on and off and having electrical wiring positioned through various combinations of upper supports and side structures. The wiring can be configured to be coupled to the electrical system of a truck and powered by same.

Still referring to FIG. 15, coupling device 202 has a cylindrical portion 204 to be coupled to an exhaust system of a motor vehicle (see FIG. 3). Coupling device 202 further includes cylindrical extensions 206 and 208 that are linear and intersect at an angle forming a V-shape. Cylindrical extensions 206 and 208 are hollow to provide fluid communication with the exhaust system (see FIGS. 3-4). The cylindrical extensions 206 and 208 open into respective tail pipes 213 and 215. That is, each tail pipe 213 and 215 is hollow and has an opening, respectively, to the environment. Ultimately, exhaust gases from a motor vehicle travels through an exhaust system from an engine, through coupling device 202 and through tail pipes 213 and 215 to be selectively exited to the environment through the openings.

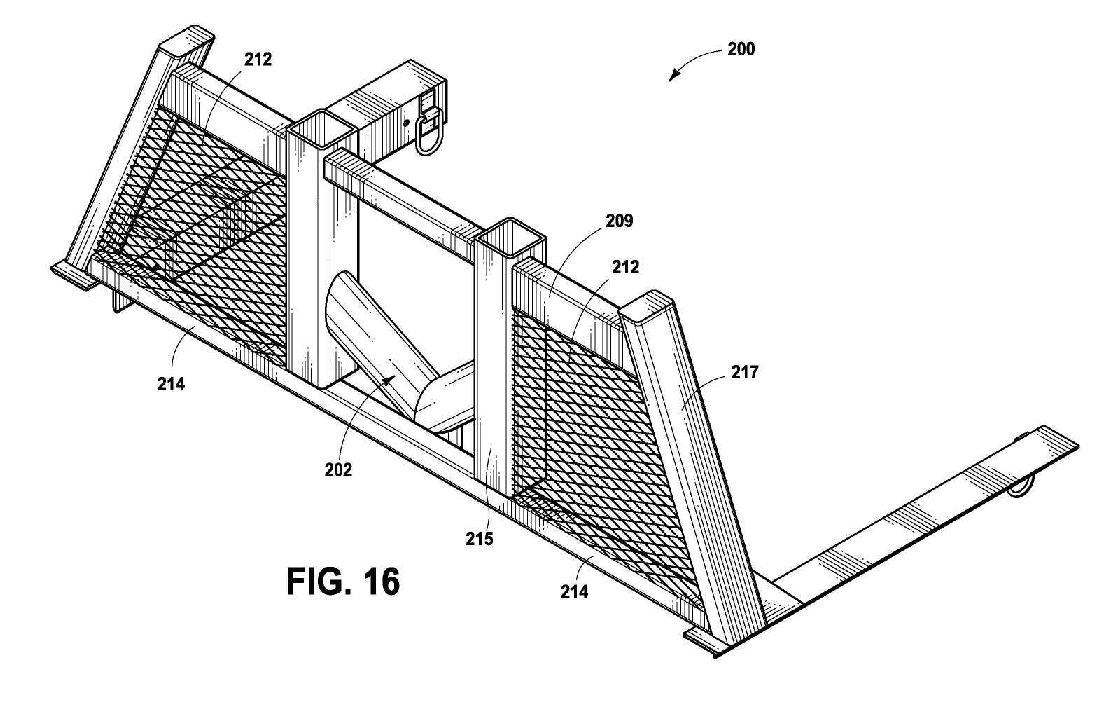

Referring to FIG. 16, such figure illustrates how screens 212 are secured in the window regions of protective barrier 200. For example, screens 212 can have periphery ends of the screen material entering the surfaces of tail pipe 215, upper support 209, side structure 217 and base support 214. Additionally, the periphery ends of the screen material of each screen 212 can be welded to the surfaces of tail pipe 215, upper support 209, side structure 217 and base support 214. Furthermore, the periphery ends of the screen material of each screen 212 can be entered into and welded to the surfaces of tail pipe 215, upper support 209, side structure 217 and base support 214. It should be understood that any one, or any combination of, periphery ends of the screen material can be secured to only one or any combination of tail pipe 215, upper support 209, side structure 217 and base support 214.

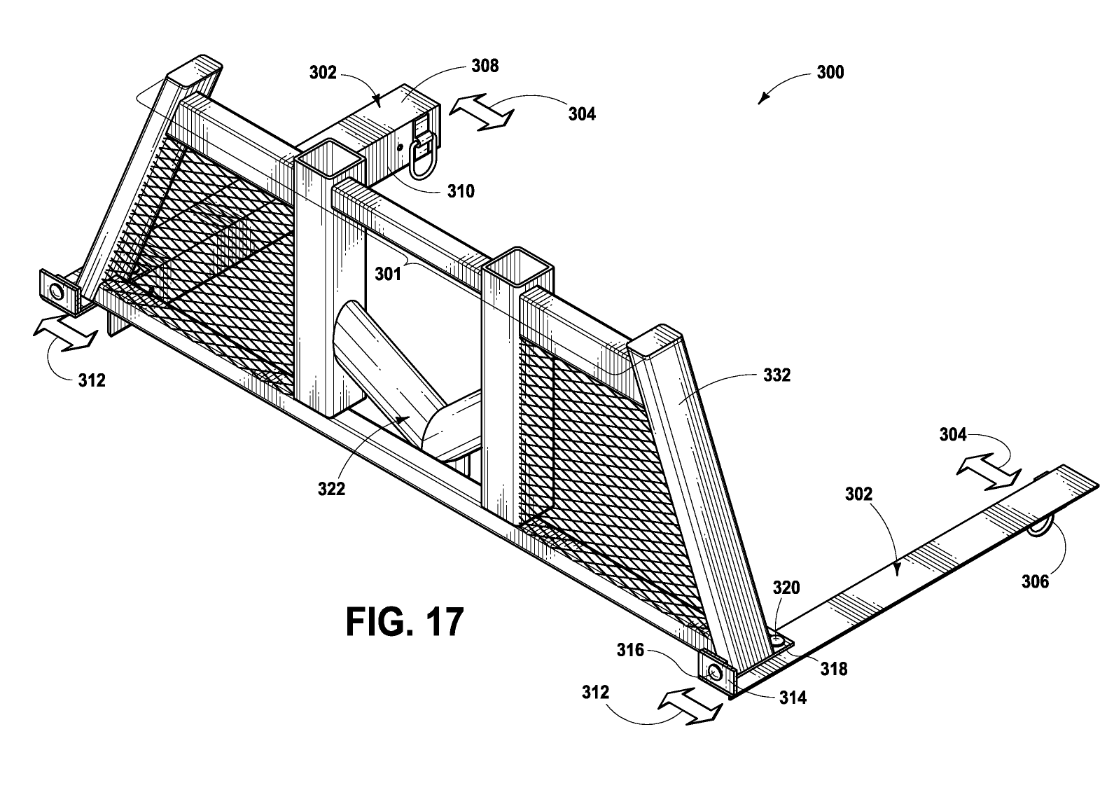

Referring to FIGS. 17-19, a protective barrier 300 is illustrated and has various structures and elements previously discussed regarding previously disclosed protective barriers, and therefore, the previously described elements/structures will not be discussed here. Protective barrier 300 includes a securement device, and as a non-limiting example, the securement device includes securement arms 302 that have a capability of movement relative the wall structure 301 to accommodate differently dimensioned motor vehicles. The capability of movement includes the securement device, one or both of the securements arms 302, being in sliding engagement with the wall structure (and therefore the protective barrier 300). More specifically, the securement arms 302 have a lateral adjustment capability (or stated another way, the protective barrier 300 has a lateral adjustment capability). That is, securement arms 302 are capable of moving in the lateral direction 304 relative to wall structure 301. As stated, this capability allows for protective barrier 300 to be secured to different trucks that have cargo beds with different width dimensions between sidewalls. Accordingly, protective barrier 300 can accommodate differently dimensioned cargo beds that have different width dimensions between respective sidewalls on which the securement arms 302 are to be secured.

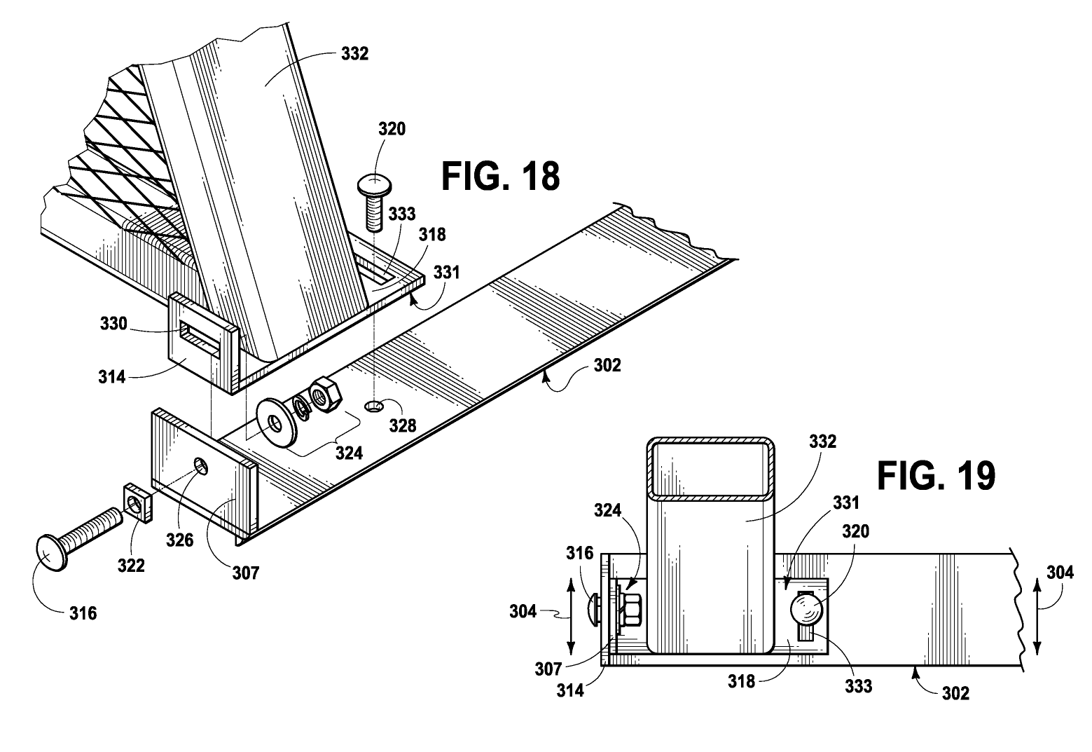

Referring to FIGS. 18-19, an L-shaped or right-angled shaped guide plate 331 is secured to the bottommost surface of side structure 332. The guide plate 331 can be bolted, welded and/or glued to side structure 332. Alternatively, guide plate 331 can be integral with the side structure 332 wherein the guide plate 331 is incorporated into the side structure 332 configuration and not provided as a separate component or structure. The guide plate 331 extends to opposite faces of side structure 332 and includes a first segment 318 that has a horizontal configuration (ultimately, generally parallel with a support surface of a cargo bed). The first segment 318 defines a first slot 333 that extends parallel with wall structure 301 (see FIG. 17). Adjacent an opposite face of side structure 332, guide plate 331 has a second segment 314 extending vertically from an end of first segment 318. The second segment 314 of guide plate 331 has a second slot 330 that extends parallel with wall structure 301 (see FIG. 17).

Still referring to FIGS. 18-19, a majority of the uppermost portion of the securement arm 302 is a planar upper surface. At one end of the planar upper surface of securement arm 302 is a section 307 extending vertically. Vertically extending section 307 has opening 326. The upper surface of securement arm 302 has opening 328 spaced from the section 307. Securement arm 302 is to be positioned relative guide plate 331 (upper surface of securement arm 302 positioned below and adjacent or against a lower surface of guide plate 331) with opening 328 of the upper surface of securement arm 302 aligned with the first slot 333 of guide plate 331. Further alignment of securement arm 302 relative guide plate 331 has opening 326 of vertically extending section 307 aligned with second slot 330 of vertical segment 314 of guide plate 331.

In this alignment between securement arm 302 and guide plate 331, a first guide pin 316 extends through opening 326 of vertical section 307 and through second slot 330 of vertical segment 314. Further in this alignment, a second guide pin 320 extends through first slot 333 of guide plate 331 and through opening 328 in upper surface of securement arm 302. The first guide pin 316 is secured in opening 326 and second slot 330 by, as one non-limiting example, a various collection of washers and nuts 324, 322. The second guide pin 320 is secured in first slot 333 and opening 328 by, as non-limiting examples, various collections of washers and nuts not shown. The nuts can be tightened on respective first and second guide pins 316, 320 to hold securement arms 302 in a selected place relative wall structure 301 (see FIG. 17).

In the tightened condition, the nuts can be loosened on at least one of the respective first and second guide pins 316, 320 until the at least one securement arm 302 is released from the tightened condition in the selected position relative the wall structure 301 (see FIG. 17) thereby allowing the at least one securement arm 302 to be selectively moved laterally 304 back and forth for a distance representative of respective lengths of respective first and second slots, 333, 330. Furthermore, while the at least one securement arm 302 is in the loosened state, the at least one securement arm 302 can be selectively positioned relative to the wall structure 301 and then the nuts can be tightened on respective first and second guide pins 316, 320 to maintain or hold the securement arm 302 in the selected position relative to the wall structure. In this manner, the respective securement arms 302 of protective barrier 300 have the capability of movement 304 relative the wall structure 301 to accommodate differently dimensioned motor vehicles.

It should be understood that only one securement arm 302, or a plurality, can be selectively and alternatively tightened and loosened for lateral movement 304. It should be further understood that structures and elements just described can be dimensioned to provide the capability for each securement arm 302 to slide laterally any distance desired and only limited by the lengths of respective first and second slots, 333, 330. An exemplary range of the lengths of respective first and second slots, 333, 330, and as non-limiting examples only, a range of 0 inches to 18 inches with an exemplary length of respective first and second slots, 333, 330 being approximately 3.0 inches. It should be finally understood that any one of the protective barriers described in this document can have this lateral adjustment capability.

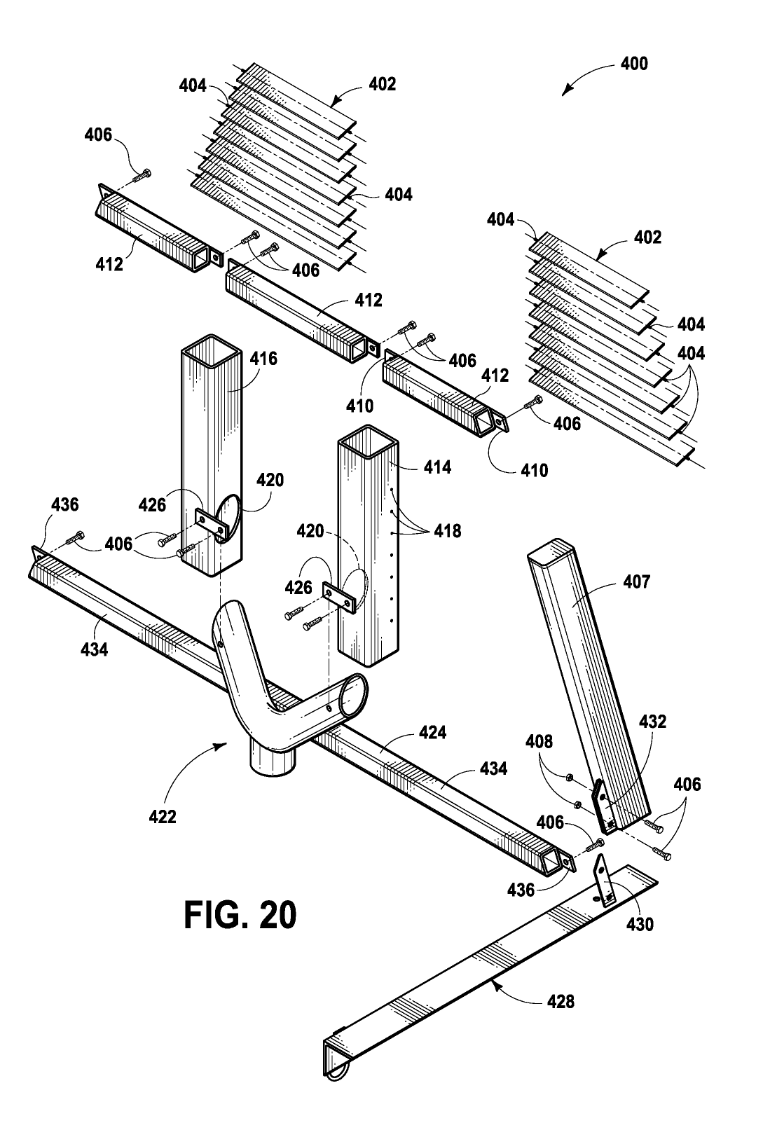

Referring to FIG. 20, a protective barrier 400 is illustrated that has a modular construction. That is, any one component or any combination of components can be selectively removed, replaced, and attached or reattached to produce, collectively, protective barrier 400. Please note that one securement arm and one side structure are not shown for simplicity of illustration and description. Each louver 402 has opposite ends with swivel pins 404 (only a few referenced with numbers) and each swivel pin 404 is positioned in an opening in either a tail pipe 414, 416 or in an opening in a side structure 407 (only openings 418 in tail pipe 414 shown but understood to be in both tail pipes 414, 416 and side structures 407). Each louver 402 can be selectively removed, replaced, and attached or reattached in protective barrier 400 by positioning respective swivel pins 404 alternatively and selectively in and out of respective openings 418.

Still referring to FIG. 20, a plurality of upper supports 412 can be selectively and alternatively removed, replaced, and attached or reattached to respective tail pipes 414, 416 and side structure 407. Flanges 410 (only a few referenced) extend laterally from opposite ends of each upper support 412 and are mated against tail pipes 414, 416 and/or side structure(s) 407 wherein openings in flanges 410 are aligned with openings (not shown) in tail pipes 414, 416 and openings (not shown) in side structure(s) 407. Bolts 406 (optionally including washers and nuts not shown) extend through aligned openings in flanges 410, tail pipes 414, 416 and side structure(s) 407 to secure upper supports 412 in protective barrier 400. It should be understood that all references to bolts in this document may, or may not, include various nuts and washers to secure bolts to structures.

Still referring to FIG. 20, base support 434 can be selectively and alternatively removed, replaced, and attached or reattached to respective side structures 407 (only one shown). Flanges 436 extend laterally from opposite ends of the base support 434 and have openings to receive bolts 406 to be secured to respective side structures 407. Side structures 407 can be selectively and alternatively removed, replaced, and attached or reattached to respective securement arms 428 (only one shown). Flange 432 of side structures 407 is mated with flange 430 of securement arms 428 with openings aligned to receive bolts 406 and nuts 408. Coupling device 422 can be selectively and alternatively removed, replaced, and attached or reattached to respective tail pipes 414, 416. Brackets 426 have a pair of openings to be aligned with openings in tail pipes 414, 416 and coupling device 422 to receive bolts 406. Openings 420 in respective tail pipes 414, 416 will be covered and aligned with opposite openings in the V-shaped portion of coupling device 422. The V-shaped portion of coupling device 422 could extend through the openings 420 in respective tail pipes 414, 416. Alternatively, the respective openings defined by the V-shaped portion of coupling device 422 could be attached to a periphery around openings 420 in tail pipes 414, 416 and the attachment could include having the V-shaped portion against the tail pipes 414, 416. Additionally, the attachment could include having the V-shaped portion against the tail pipes 414, 416 and a weld and/or an adhesive between the V-shaped portion and tail pipes 414, 416.

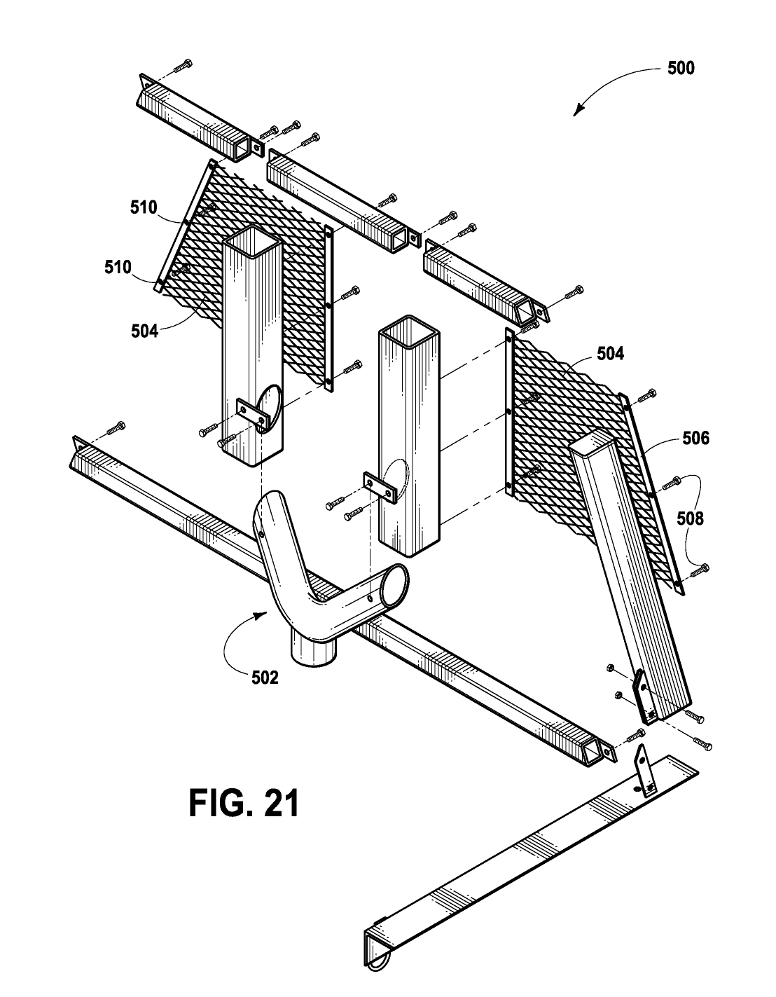

Referring to FIG. 21, a protective barrier 500 is illustrated that has a modular construction. That is, any one component can be selectively and alternatively removed, replaced, attached and/or reattached to produce protective barrier 500. Structures and components of protective barrier 500 already described with respect to protective barrier 400 are not described for protective barrier 500. Protective barrier 500 has screens 504 that can be selectively and alternatively removed, replaced, attached and/or reattached to respective tail pipes and respective side structures. On opposite sides of each screen 504 there are attachment bars 506 (only one numerically referenced) extending along the side edges of screen 504. Each attachment bar 506 has a plurality of openings 510 (only one numerically referenced) spaced along the length of attachment bars 506. Openings 510 are to be aligned with openings in respective tail pipes and respective side structures (openings in respective tail pipes and respective side structures not shown) to receive bolts 508 for securement of screens 504 in protective barrier 500.

Referring to FIG. 22, a small portion of a protective barrier 360 is illustrated that includes the capability for at least one louver 368 to rotate about a longitudinal axis which is defined extending along the length of a louver 368. That is, the rotational action of the louver is about the longitudinal axis. Protective barrier further includes pivot pins 370 (only one shown) that rotationally support each end of each louver 368, one in a tail pipe 366 and one in a side structure 364. Accordingly, each louver 368 is capable of rotation about the longitudinal axis extending between respective pivot pins 370. A rotation knob 374 extends from at least one end of each louver 368 and is spaced from centrally located pivot pin 370. The rotation knob 374 extends through arcuate or curved groove 372 in tail pipe 366. Engaging, manipulating and applying pressure with a finger or extension tool to rotation pin 374 will move rotation knob 374 back and forth through groove 372 along direction 376. This movement of rotation knob 374 will rotate louver 368 about the longitudinal axis on pivot pins 370. The periphery of groove 372 defined by tail pipe 366 with have a plurality of cogs or teeth (not shown). Each one of the plurality of cogs or teeth is capable of receiving and holding the rotation knob 374 stationary in a selected position which correspondingly holds each louver 368 in a selected position.

Accordingly, still referring to FIG. 22, each louver 368 can be held stationary in any position in its rotation about the longitudinal axis limited only by the length of the curvature of the groove 372. That is, as rotation knob 374 is forced through groove 372, the rotation knob 374 can flex to rise over each one of the cogs or teeth until the rotation knob 374 is selectively allowed to flex back to rest in a space between two cogs or teeth. As the rotation knob 374 is selectively held in the space between two cogs, the louver 368 is correspondingly selectively positioned in a stationary position about the longitudinal axis. For example, if groove 372 is/was formed as a circle in tail pipe 366, then rotation knob 374 could rotate 360 degrees with the corresponding louver 368 capable of rotation for 360 degrees. If there are/were 360 cogs in groove 372 formed as a circle, and each cog is located at each degree of rotation above the longitudinal axis, then the rotation knob 374 and correspondingly the louver 368, could be held stationary in position at each degree of rotation of 360 degrees about the longitudinal axis.

As a non-limiting example, groove 372 extends to form one fourth of a circle allowing for a louver 368 to rotate 90 degrees about the longitudinal axis and there is a cog located in groove 372 at each one degree between 0 and 90 degrees. If a horizontal position of louver 368 is represented as the 0 degree position and a vertical position of louver 368 is represented as the 90 degree position, then the louver 368 could be held stationary in each degree positioned between 0 degrees and 90 degrees For example, louver 368 can be held at a 0 degree position which is the horizontal position, or at a 1 degree position, a 2 degree position . . . through to . . . the 88^{th} degree position, the 89^{th} degree position and finally the 90^{th} degree position which is the louver 368 in the vertical position.

It should be understood that only one louver 368 of protective barrier 360 may have the capability to rotate and be held in a stationary position. It should be further understood that and combination of number of the plurality of louvers 368 of protective barrier 360, including all the louvers 368, may have the capability to rotate and be held in a stationary position. It should be additionally understood that each protective barrier described throughout this document can have the capability for one or more of the louvers to have the capability to rotate. It should be still further understood that groove 372 can be provided in an outside surface of side structure 364 (not shown) and a rotation knob 374 extending through groove 372 through side structure 364 wherein the rotation knob 374 can be accessed and moved/manipulated through groove 372 to position louver 368 in the selected positions described previously. The groove 372 and rotation knob 374 through side structure 364 can be the only groove 372 and rotation knob 374 in protective barrier 360 or a corresponding groove 372 and rotation knob 374 can be in tail pipe 366.

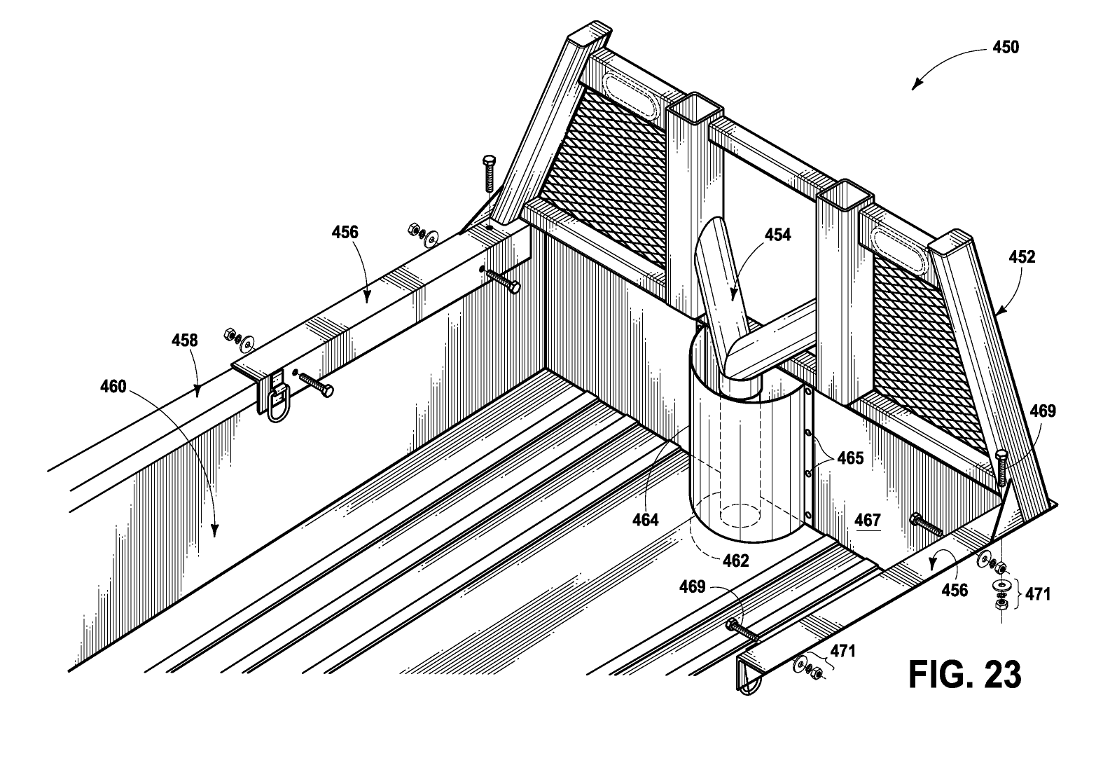

Referring to FIG. 23, a protective barrier 450 is illustrated that includes a shield 464 that protects at least a portion of coupling device 454 and at least a portion 462 of an exhaust system from cargo (not shown) that could be placed in the cargo bed 460. Shield 464 is bolted 465 to a front, vertically extending surface 467 of cargo bed 460. Still further, bolts 469 and corresponding collection 471 of washers and nuts are illustrated which are used to secure securement arms 456, and ultimately protective barrier 450, to upper surface 458 of sidewalls of cargo bed 460.

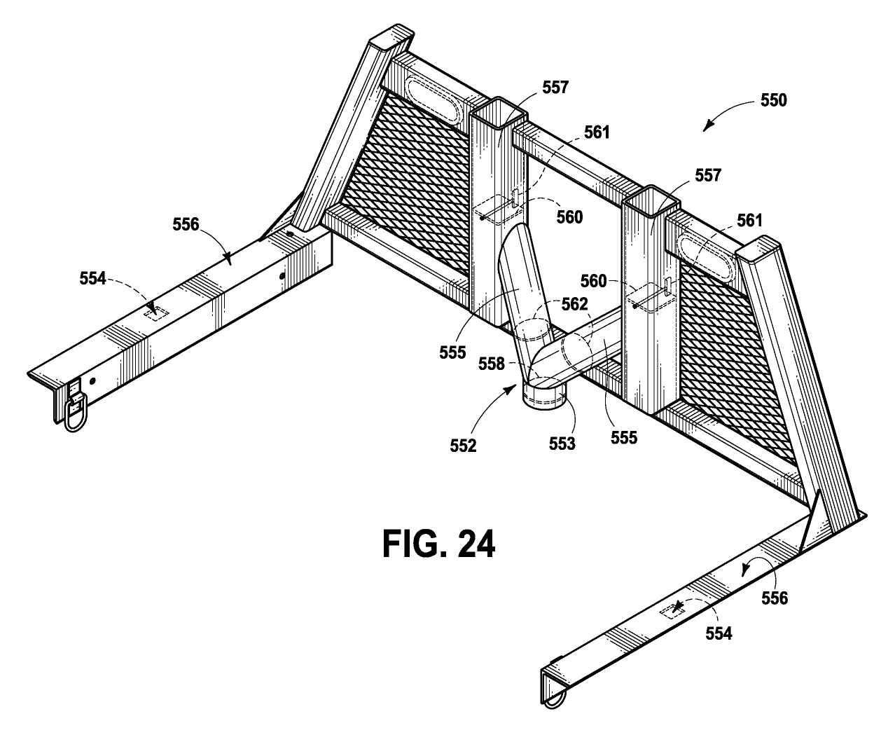

Referring to FIG. 24, a protective barrier 550 is illustrated that includes at least one or more valves. For example, coupling device 552 has a cylindrical portion 553 (for ultimate connection with an exhaust system of a motor vehicle) and a V-shaped portion 555. As one non-limiting example, each cylinder portion 553 has at least one valve 558 and each extension of the V-shaped portion 555 has at least one valve 562. Each tail pipe 557, or only one, has at least one valve 560. It should be understood that each structure of protective barrier 550 that has a valve can have a plurality of valves or no valves at all. Valves can be selectively closed or opened and selectively partially closed or opened to selectively control the volume of exhaust gases moving through a structure having a valve. For example, if valve 558 in cylindrical portion 553 is completely closed, such could completely impede any exhaust gases from traveling through protective barrier 550 wherein the exhaust gases must travel through an existing exhaust system of the motor vehicle and exit from that exhaust system. As a non-limiting example only, each valve 560 in tail pipes 557 has a rotating pin/knob 561 extending from protective barrier 550 to allow for direct contact and manual manipulation by a finger/hand for selective positioning of valves 560. That is, each valve can be selectively positioned or rotated to partially close (as a percentage of closing equal to 0% (completely opened), 1% . . . to 98%, 99% to 100% (completely closed)) or partially open (as a percentage of opening equal to 0% (completely closed), 1% . . . to 98%, 99% to 100% (completely opened)) the fluid communication in the coupling device 552 and/or tail pipe 557. Each valve can be configured to be entirely mechanically operated (other than finger/hand manipulation), entirely electrically operated, or a combination of mechanically/electrically operated.

Still referring to FIG. 24, securement arms 556 have openings 554 that can correspond and align with openings in sidewalls (not shown) of cargo beds to allow for the use of the openings in the cargo beds. For example, the openings can be used to receive straps for strapping cargo down in a cargo bed.

It should be understood that any one structure or component of the protective barriers disclosed in this document, including as non-limiting examples, side structures, base structure, tail pipes, upper supports, screens, louvers, and securements devices such as flanges and securement arms, can be formed from any of a variety of materials such as plastics, thermoplastics, metals, metal alloys and any combination thereof.

Exemplary metals or similar material include tin, iron, aluminum, magnesium, zinc and copper, and alloys of any one metal or any combination of the metals. The metals or similar material can be characterized as being ductile and/or malleable. Being ductile and malleable allows for the metal or similar material to be molded into various forms and hardened. Still other exemplary components or structures of the protective barrier include alloys of metal such as steel, stainless steel, brass and bronze.

Exemplary plastics include thermoplastic, thermosetting plastic and similar material. These plastic materials can be characterized as being ductile and/or malleable which provides the capability of being molded into various forms and hardened. Furthermore, these plastic materials can be generally characterized by any of various nonmetallic compounds, synthetically produced, usually from organic compounds by polymerization, or formed into pliable sheets or films, fibers, flexible or hard foams. Example plastic materials include polystyrene, acrylonitrile butadiene styrene (ABS), polyamide, polypropylene, polyethylene, and polyvinyl chloride (PVC). Other exemplary nonmetallic compounds include spun glass or fiberglass which is a composite of extremely fine fibers of glass combined with polymers and epoxies.

It should be understood that any one structure or component of the protective barriers disclosed in this document can be formed by various exemplary one or combination of methods such as injection molding. Injection molding is a manufacturing process using thermoplastic and/or thermosetting plastic materials described previously (example plastic materials include polystyrene, acrylonitrile butadiene styrene (ABS), polyamide, polypropylene, polyethylene, and polyvinyl chloride (PVC)). An overview of an injection molding process includes molten plastic being injected at high pressure into a mold wherein the mold is an inverse design of the shape of exemplary one structure or component of the protective barriers. Still other exemplary methods of forming exemplary one structure or component of the protective barriers include die casting. Die casting is a manufacturing process using metals and/or metal alloys described previously (example metals or metal alloys include tin, iron, aluminum, magnesium, zinc and copper, and alloys of any one metal or any combination of the metals). An overview of a die casting process includes molten metal being injected at high pressure into a mold wherein the mold is an inverse design of the shape of exemplary one structure or component of the protective barriers. Yet other exemplary methods of forming exemplary one structure or component of the protective barriers include: permanent mold casting, extrusion, forging, sand casting, powder metallurgy, ceramic mold casting, plaster mold casting and centrifugal casting.

Exemplary wall structures of the protective barriers described throughout his document, and as non-limiting examples, are generally planar configurations that have the capability to be selectively, removably securable to a motor vehicle. However, a wall structure can be permanently secured to a motor vehicle. The capability of the wall structures (and therefore the protective barriers) to be selectively, removably securable is provided by the securement devices which include, as non-limiting examples, collectively the flanges 18 and 20, and variously described securements arms herein. Exemplary securement arms are elongated structures, removably securable to the wall structure, that may, or may not, be in sliding engagement with the wall structure. The wall structures, as non-limiting examples, include frame structures, for example, that define window regions described herein. The exemplary tail pipes described herein, as non-limiting examples, are tubular structures and/or hollow structures in the wall structure or frame and are passageways that are configured to be in fluid communication with an exhaust system of a motor vehicle. The various coupling devices described throughout this document are removably securable to the wall structures and, as non-limiting examples, are passageways that provide fluid communication between the tail pipes and the exhaust system.

While the disclosure of this application was motivated by the above design considerations, it is in no way so limited. The invention is only limited by the accompanying claims as literally worded, without interpretative or other limiting reference to the specification, and in accordance with the doctrine of equivalents.

Other aspects and implementations are contemplated.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A protective barrier for a motor vehicle comprising:
a wall structure removably securable to a motor vehicle; and
at least one tubular structure in the wall structure, the least one tubular structure is configured to be coupled in fluid communication with an exhaust system of a motor vehicle.

2. The protective barrier of claim 1 wherein the at least one tubular structure comprises a tail pipe for the exhaust system.

3. The protective barrier of claim 1 further comprising a coupling device removably securable to the wall structure and configured to provide the fluid communication between the at least one tubular structure and the exhaust system.

4. The protective barrier of claim 1 wherein the at least one tubular structure comprises a pair of spaced tubular structures in the wall structure.

5. The protective barrier of claim 1 wherein the at least one tubular structure comprises a valve.

6. A protective barrier for a motor vehicle comprising:
a wall structure; and
a securement device configured to removably secure the wall structure to a motor vehicle, the securement device comprising an adjustment capability allowing the wall structure to be removably secured to differently dimensioned motor vehicles.

7. The protective barrier of claim 6 wherein the securement device is in sliding engagement with the wall structure.

8. The protective barrier of claim 6 wherein the securement device comprises a flange structure removably securable to the wall structure.

9. The protective barrier of claim 6 wherein the securement device comprises an elongated structure removably securable to the wall structure.

10. The protective barrier of claim 6 wherein the securement device comprises an elongated structure in sliding engagement with the wall structure.

11. The protective barrier of claim 6 wherein the securement device comprises a pair of spaced elongated structures, at least one of the pair of the elongated structures is in sliding engagement with the wall structure.

12. A protective barrier for a motor vehicle comprising:
a frame removably securable to a motor vehicle and defining a window region; and
a hollow structure in the frame and defining a passageway configured to be in fluid communication with an exhaust system of the motor vehicle.

13. The protective barrier of claim 12 wherein the window region is at least partially covered by at least one of the following structures removably securable to the frame: a screen, a louver, plastic and fiberglass.

14. The protective barrier of claim 12 further comprising at least one louver removably securable to the frame in the window region and configured for rotation about a longitudinal axis defined by the louver.

15. The protective barrier of claim 14 wherein the at least one louver is configured to be selectively positioned in any one of a plurality of incremental angular locations about the longitudinal axis.

16. The protective barrier of claim 12 wherein the frame comprises a modular configuration, the modular configuration comprising at least one modular component that can be selectively removed, replaced, attached or reattached in the modular configuration.
